(19) United States
(12) Patent Application Publication
(10) Pub. No.: US 2005/0085246 A1
(43) Pub. Date: Apr. 21, 2005

(54) Network support for computerized event input and notification

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: PATTI & BRILL, ONE NORTH LASALLE STREET, 44TH FLOOR, CHICAGO, IL, 60602, US

(21) Appl. No.: 10/687,154

(22) Filed: Oct. 16, 2003

(51) Int. Cl. H04Q 7/20

(52) U.S. Cl. 455/466

(57) ABSTRACT

The system and method support the input of events and the subsequent event notification to a mobile handset in the form of a SMS message. In one embodiment the method may have the steps of: detecting an occurrence of an event on a public data network communication system; automatically creating an SMS message; and automatically delivering the SMS message to a designated mobile handset. The system implements the method.

### TECHNICAL FIELD

The present invention relates to wireless telephony in general, and, more particularly, to embodiments of a method and system that support the input of events and the subsequent event notification to a mobile handset in the form of a SMS message.

### BACKGROUND OF THE INVENTION

Wireless communication systems are constantly evolving. System designers are continually developing greater numbers of features for both service providers as well as for the end users. In the area of wireless phone systems, cellular based phone systems have advanced tremendously in recent years. Wireless phone systems are available based on a variety of modulation techniques and are capable of using a number of allocated frequency bands. Available modulation schemes include analog FM and digital modulation schemes using Time Division Multiple Access (TDMA) or Code Division Multiple Access (CDMA). Each scheme has inherent advantages and disadvantages relating to system architecture, frequency reuse, and communications quality. However, the features the manufacturer offers to the service provider and which the service provider offers to the consumer are similar between the different wireless systems.

Regardless of the modulation scheme in use, the wireless phone available to the end user has myriad features implemented. Nearly all wireless phones incorporate a display that allows the user to enter text banners, display dialed numbers, and display incoming caller numbers. Additionally, wireless phones may incorporate electronic phonebooks, speed dialing, single button voicemail access, and messaging capabilities.

The features described above present only a sample of features that are capable of, or have already been, implemented into wireless phone systems. Any individual feature is capable of implementation into some or all of the wireless systems using the modulation schemes mentioned above. A particularly useful feature provides messaging capability within phones. The Short Message Services (SMS) feature used in a CDMA wireless communication system allows for information transfer to and from a wireless phone. However, the implementation of SMS is not limited to use in a CDMA system. The description of SMS in a CDMA system is merely provided as a foundation for the discussion of the preferred embodiment of the invention presented below. Short Message Services (SMS) are used to allow the communication of alphanumeric messages to wireless phones. As is well known in the art, a human must typically key in a SMS message.

Mobile subscribers are becoming increasingly connected to mobile stations (also referred to as mobile handsets and cell phones), which are often viewed as a necessary accessory during waking hours. Slow-moving industries, like banking, continue to send overdraft notices by U.S. mail, although recently some banks have begun utilizing email. However, as careers and ISPs change, there is a growing staleness to email addresses. Given the advances in number portability, it is likely that the mobile phone will evolve as the universally accepted way to contact a person over the long term.

A person in today's society may receive many communications, ranging from checking account overdraft notices to mortgage payment reminders. The threshold for a particular situation would be determined in advance between the mobile user and the business (for example, a user may want his bank to notify him when his checking account balanced falls below $500.00).

Thus there is a need in the prior art for a network solution for providing necessary support for acceptance and reporting of various relevant situations to mobile handset users.

### SUMMARY

The following summary of some embodiments of the invention is provided to facilitate an understanding of some of the innovative features unique to the present invention and is not intended to be a full description. A full appreciation of the various aspects of the invention can be gained by taking the entire specification, claims, drawings, and abstract as a whole.

In general terms an embodiment of the present system for input of events and subsequent event notification to at least one mobile handset, may have a network operatively connected to at least a public data network communication system and to at least one mobile handset. The network may have an input module operatively connected to the public data network communication system, a conversion module operatively connected to the input module; and a communication module operatively connected to the conversion module and to the at least one mobile handset. When a computer generated message, which is related to an event, is inputted from the public data network communication system, the computer generated message in converted to a notification message in SMS form, and the notification message is automatically sent in SMS form from the network to the at least one mobile handset.

Another embodiment of the present method for input of events and subsequent event notification to at least one mobile handset may have the following steps of: inputting to a network a computer generated message that is related to an event by recognizing that the computer generated message is related to the event and accepting the event as an input to the network, wherein, upon inputting of the computer generated message that is related to an event, the network automatically checks the designation part for a valid mobile handset designation, and, if the mobile handset designation is valid, checks the information part for a valid event format; converting the computer generated message to a notification message in SMS form; and automatically sending the notification message in SMS form from the network to at least one mobile handset.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 depicts a block diagram illustrative of one embodiment of the present system.

FIG. 2 illustrates a very general flow chart of logical operational steps that may be followed in accordance with one embodiment of the present method.

FIG. 3 illustrates another flow chart of logical operational steps that may be followed in accordance with an embodiment of the present method.

### DETAILED DESCRIPTION

The particular values and configurations discussed in these non-limiting examples can be varied and are cited merely to illustrate an embodiment of the present invention and are not intended to limit the scope of the invention.

Embodiments of the present system and method provide a network solution for providing the necessary support for event acceptance and reporting, by providing an interface to accept events, and using SMS as the vehicle to report those events to the designated mobile subscribers. An event may consist of a sequence of characters and an associated mobile handset telephone number. The event may be representative of, for example, checking account overdraft notices, mortgage payment reminders, etc. Also, an event may be representative of communications from any type of business, person, etc., and not just the banking industry.

The textual nature of SMS allows computers to be able to compose SMS-compatible messages for a wide range of situations without human interaction. One embodiment of the methodology provides for the network to automatically report an event (i.e., deliver the associated SMS message) to a designated mobile subscriber. To accomplish this the network interfaces with a public data network (i.e., URL) from which a computer-generated message may be input. Upon reception of the input event, the network automatically delivers the message in SMS form to the designated mobile subscriber.

Embodiments of the present method and system provide a data interface to the wireless network capable of recognizing and accepting messages to deliver to a designated mobile handset. No human intervention is necessarily required to send notification of events such as checking account overdraft, etc. As long as a computer is able to detect when a certain event has occurred, the data interface allows the computer to create an associated message than is to be automatically delivered to the mobile handset.

In general terms embodiments of the present method and system provide for input of events to a network operatively connected to a public data network communication system and subsequent event notification to at least one mobile handset. One embodiment of the present method may have the steps of: detecting an occurrence of an event on a public data network communication system; automatically creating an SMS message; and automatically delivering the SMS message to a designated mobile handset.

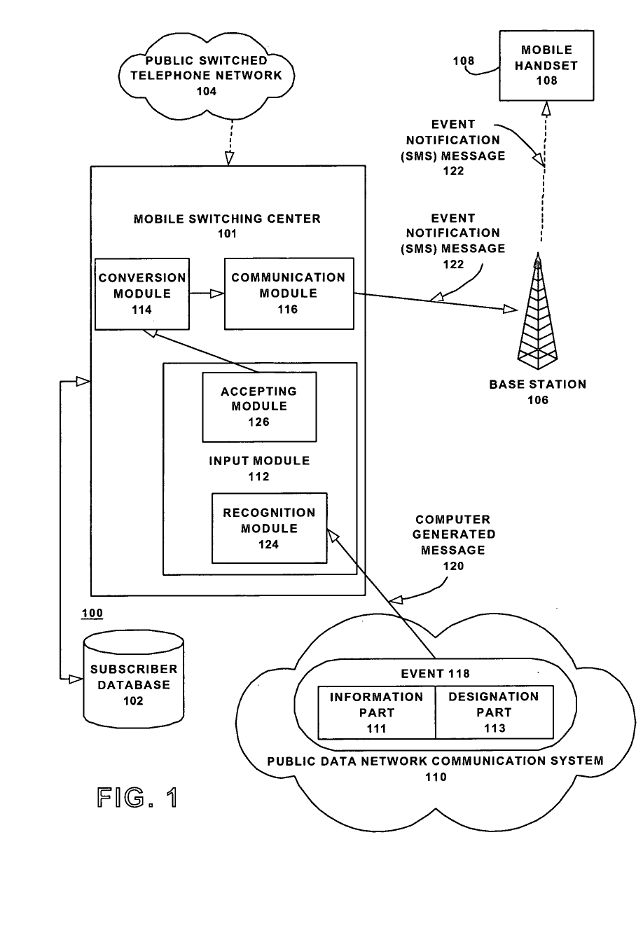

Reference is now made to FIG. 1 wherein there is shown an exemplary wireless network 100. A public switched telephone network (PSTN) 104 is operatively connected to a mobile switching center (MSC) 101. The MSC 101 is in communication with at least one base station 106. The base station 106 is the physical equipment, illustrated for simplicity as a radio tower, which provides radio coverage to the geographical part of a cell for which it is responsible. The base station 106 may be in communication with mobile stations, such as mobile station 108 (also referred to as a mobile subscriber).

With further reference to FIG. 1, a subscriber database 102 may contain a home location register, which is a database maintaining and storing subscriber information such as subscriber profiles, current location information, international mobile subscriber Identity numbers, and other administrative information. The subscriber services associated with the mobile station 108 are defined in a subscriber profile that may be stored in the home location register in the subscriber database 102. The home location register may be co-located with a given MSC 101, integrated with the MSC 101, or alternatively service multiple MSCs. The subscriber database may also include a visitor location register that has information about all of the mobile stations currently located within an area of the base station 106.

The mobile station 108 may consist of the mobile equipment (the terminal) and a smart card called the subscriber identity module (SIM). The SIM provides personal mobility, so that the user can have access to subscribed services irrespective of a specific terminal. By inserting the SIM card into another GSM terminal, the user is able to receive calls at that terminal, make calls from that terminal, and receive other subscribed services.

The mobile equipment is uniquely identified by the international mobile equipment identity (IMEI). The SIM card contains the international mobile subscriber identity (IMSI) used to identify the subscriber to the system, a secret key for authentication, and other information. The IMEI and the IMSI are independent, thereby allowing personal mobility. The SIM card may be protected against unauthorized use by a password or personal identity number.

The base station 106 may be composed of two parts, the base transceiver station (BTS) and the base station controller (BSC). These communicate across the standardized Abis interface, allowing (as in the rest of the system) operation between components made by different suppliers.

The base transceiver station houses the radio tranceivers that define a cell and handles the radio-link protocols with the mobile station. The base station controller manages the radio resources for one or more base transceiver stations. It handles radio-channel setup, frequency hopping, and handovers, as described below. The base station controller is the connection between the mobile station 108 and the mobile switching center 101 (MSC).

The mobile switching center 101 (MSC) acts like a normal switching node of the PSTN 104 or ISDN (not shown), and additionally provides all the functionality needed to handle a mobile subscriber 108, such as registration, authentication, location updating, handovers, and call routing to a roaming subscriber. These services are provided in conjunction with several functional entities.

The home location register (HLR) and visitor location register (VLR) in the subscriber database 102, together with the MSC 101, provide the call-routing and roaming capabilities of system. The HLR contains all the administrative information of each subscriber registered in the corresponding network, along with the current location of the mobile subscriber 108. The location of the mobile subscriber 108 is typically in the form of the signaling address of the VLR associated with the mobile station 108.

The visitor location register (VLR) in the subscriber database 102, contains selected administrative information from the HLR, necessary for call control and provision of the subscribed services, for each mobile station 108 currently located in the geographical area controlled by the VLR. Although each functional entity can be implemented as an independent unit, all manufacturers of switching equipment to date implement the VLR together with the MSC 101, so that the geographical area controlled by the MSC 101 corresponds to that controlled by the VLR, thus simplifying the signaling required. Note that the MSC 101 contains no information about particular mobile stations, which information is stored in the location registers.

Also as depicted in FIG. 1, this embodiment of the system for input of events and subsequent event notification to at least one mobile handset 108 may have a network 100 operatively connected to at least a public data network communication system 110 and to the at least one mobile handset 108. The network 100 may have an input module 112 operatively connected to the public data network communication system 110, a conversion module 114 at least operatively connected to the input module 112; and a communication module 116 at least operatively connected to the conversion module 114 and to the at least one mobile handset 108. When a computer generated message 120, which is related to an event 118, is inputted from the public data network communication system 110, the computer generated message 120 is converted to a notification message 122 in SMS form, and the notification message 122 is automatically sent in SMS form from the network 100 to the at least one mobile handset 108.

In a further embodiment the input module 112 may have a recognition module 124 for recognizing that the computer generated message 120 is related to an event 118, and an accepting module 126 for accepting the event 118 as an input to the network 100. The event 118, for example, may have an information part 111; and a designation part 113 that designates a mobile handset 108. The designation part 113 of the event 110 may be representative of a mobile handset designation, and the information part 111 of the event 118 may be representative of a valid event format. After inputting of the computer generated message 120 that is related to an event 118, the network 100 in one embodiment automatically converts the computer generated message 120 to a notification message 122 in SMS form and automatically delivers the notification message 122 in SMS form to the designated mobile handset 108.

The Input Module 112 receives an event message via its external interface (i.e., IP address and port number) encapsulated in an event message format (e.g., EVENT-MESSAGE-HEADER followed by EVENT-DESTINATION (i.e., a mobile handset telephone number), followed by EVENT-DELIMITER followed by EVENT-TEXT (a variable length text message) followed by EVENT-TRAILER. This represents one of many possible event message formats. The Recognition Module 124 parses each input message to verify the HEADER, DELIMITER and TRAILER fields. All valid EVENT-MESSAGEs are forwarded to the Accepting Module 126; improperly formatted EVENT-MESSAGEs are ignored. The Accepting Module 126 verifies the validity of the destination mobile telephone number, including verification that the particular mobile handset supports SMS. If so, the Accepting Module 126 forwards the EVENT-MESSAGE to the Conversion Module 114, which translates special character sequences into graphical symbols (e.g., “\0A”→ [symbol] ). The converted EVENT-MESSAGE is then sent to the Communication Module 116 for output to the destination mobile handset. The Communication Module 116 is the same module as used to send subscriber-initiated SMS messages to the mobile handset, and is illustrated here for completeness.

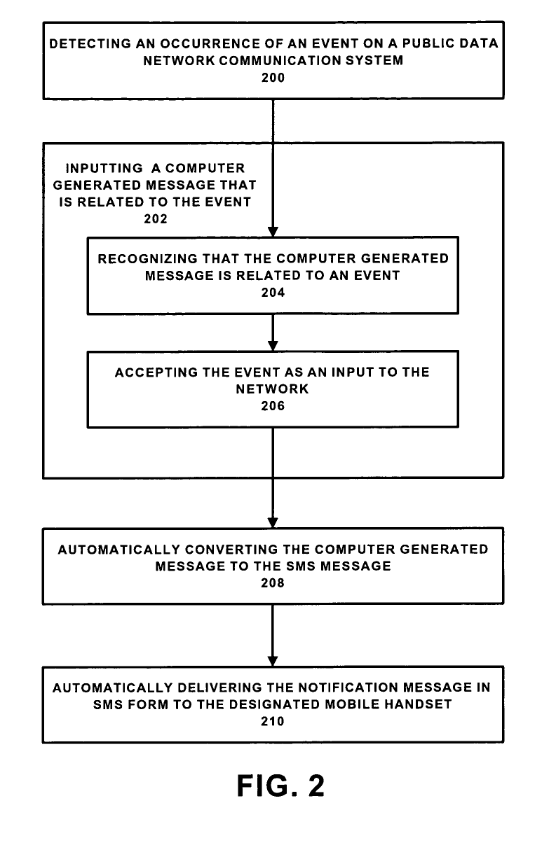

As depicted in FIG. 2, one embodiment of the present method may have the steps of: detecting an occurrence of an event on a public data network communication system (step 200); automatically creating an SMS message (step 208); and automatically delivering the SMS message to a designated mobile handset (step 210).

In a further embodiment the present method may further have the steps of: inputting to the network a computer generated message that is related to the event (step 202); and converting the computer generated message to the SMS message (step 208). In yet another embodiment the present method may have the steps of: recognizing, by the network, that the computer generated message is related to an event (204); and accepting, by the network, the event as an input to the network (step 206). Upon inputting of the computer generated message that is related to an event, the network may automatically convert the computer generated message to a notification message in SMS form and may automatically deliver the notification message in SMS form to the designated mobile handset.

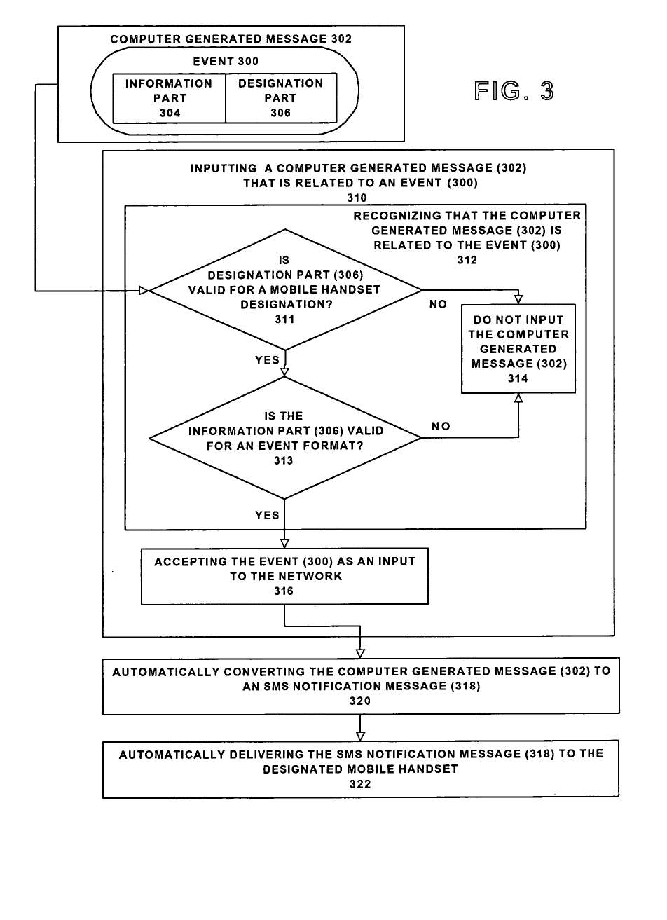

An event 300, represented by a computer generated message 302 may typically have an information part 304 and a designation part 306 that designates a mobile handset. Another embodiment of the present method, as depicted in FIG. 3, for input of events and subsequent event notification to at least one mobile handset may have the following steps of: inputting (step 310) to a network a computer generated message 302 by recognizing (step 312) that the computer generated message 302 is related to the event 300 and accepting (step 316) the event 300 as an input to the network, wherein, upon inputting of the computer generated message 302 that is related to an event 300, the network automatically checks the designation part 306 for a valid mobile handset designation (step 311), and, if the designation part 306 is valid, checks the information part 304 for a valid event format (step 313), and, if either or both of the designation part 306 and the information part 304 is not valid, not inputting the computer generated message 302 (step 314); converting, if the information part 304 is valid, the computer generated message 302 to a notification message 318 in SMS form (step 320); and automatically sending the notification message 318 in SMS form from the network to at least one mobile handset (step 322).

Thus, the embodiments of the present system and method fulfill the need in the prior art for a network solution for providing necessary support for acceptance and reporting of various relevant situations to mobile handset users. The present network solution provides the necessary support for event acceptance and reporting, by utilizing an interface to accept events, and by using SMS as the vehicle to report those events to the designated mobile subscribers.

The method and system of the present invention may be implemented in hardware, software, or combinations of hardware and software. In a software embodiment, portions of the present invention may be computer program products embedded in computer readable medium. Portions of the system may employ and/or comprise a set and/or series of computer instructions written in or implemented with any of a number of programming languages, as will be appreciated by those skilled in the art.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

1. A method for input of events to a network operatively connected to a public data network communication system and subsequent event notification to at least one mobile handset, comprising the steps of:
detecting an occurrence of an event on a public data network communication system;
automatically creating an SMS message; and
automatically delivering the SMS message to a designated mobile handset.

2. The method according to claim 1, wherein the method further comprises: inputting to the network a computer generated message that is related to the event; and converting the computer generated message to the SMS message.

3. The method according to claim 2, wherein the method further comprises: recognizing, by the network, that the computer generated message is related to an event; and accepting, by the network, the event as an input to the network.

4. The method according to claim 2, wherein, upon inputting of the computer generated message that is related to an event, the network automatically converts the computer generated message to a notification message in SMS form and automatically delivers the notification message in SMS form to the designated mobile handset.

5. The method according to claim 2, wherein the event comprises: an information part; and a designation part that designates a mobile handset.

6. The method according to claim 5, wherein, upon inputting of the computer generated message that is related to an event, the network automatically checks the designation part for a valid mobile handset designation, and, if the mobile handset designation is valid, checks the information part for a valid event format.

7. The method according to claim 5, wherein, upon inputting of the computer generated message, the network automatically checks the designation part for a valid mobile handset designation.

8. The method according to claim 5, wherein, upon inputting of the computer generated message, the network automatically checks the information part for a valid event format.

9. A method for input of events and subsequent event notification to at least one mobile handset, comprising the steps of:
inputting to a network a computer generated message that is related to an event;
converting the computer generated message to a notification message in SMS form; and
automatically sending the notification message in SMS form from the network to at least one mobile handset.

10. The method according to claim 9, wherein the method further comprises: recognizing, by the network, that the computer generated message is related to an event; and accepting, by the network, the event as an input to the network.

11. The method according to claim 9, wherein the event comprises: an information part; and a designation part that designates a mobile handset.

12. The method according to claim 11, wherein, upon inputting of the computer generated message that is related to an event, the network automatically checks the designation part for a valid mobile handset designation, and, if the mobile handset designation is valid, checks the information part for a valid event format.

13. The method according to claim 11, wherein, upon inputting of the computer generated message, the network automatically checks the designation part for a valid mobile handset designation.

14. The method according to claim 11, wherein, upon inputting of the computer generated message, the network automatically checks the information part for a valid event format.

15. The method according to claim 9, wherein, after inputting of the computer generated message that is related to an event, the network automatically converts the computer generated message to a notification message in SMS form and automatically delivers the notification message in SMS form to the designated mobile handset.

16. A system for input of events and subsequent event notification to at least one mobile handset, comprising:
a network operatively connected to at least a public data network communication system and to at least one mobile handset;
the network having an input module operatively connected to the public data network communication system;
the network having a conversion module operatively connected to the input module; and
the network having a communication module operatively connected to the conversion module and to the at least one mobile handset;
wherein when a computer generated message, which is related to an event, is inputted from the public data network communication system, the computer generated message in converted to a notification message in SMS form, and the notification message is automatically sent in SMS form from the network to the at least one mobile handset.

17. The system according to claim 16, wherein the input module has a recognition module for recognizing that the computer generated message is related to an event; and an accepting module for accepting the event as an input to the network.

18. The system according to claim 16, wherein the event comprises: an information part; and a designation part that designates a mobile handset.

19. The system according to claim 18, wherein the designation part of the event is representative of a mobile handset designation, and wherein the information part of the event is representative of a valid event format.

20. The system according to claim 16, wherein, after inputting of the computer generated message that is related to an event, the network automatically converts the computer generated message to a notification message in SMS form and automatically delivers the notification message in SMS form to the designated mobile handset.
